(19) United States
(12) Patent Application Publication
(10) Pub. No.: US 2004/0014506 A1
(43) Pub. Date: Jan. 22, 2004

(54) Casing for a mobile telephone

(76) Inventor: Martti Kemppinen, Mikkeli (FI)

Correspondence Address: YOUNG & THOMPSON, 745 SOUTH 23RD STREET 2ND FLOOR, ARLINGTON, VA, 22202

(21) Appl. No.: 10/332,572

(22) PCT Filed: Jun. 20, 2001
(86) PCT No.: PCT/FI01/00592

(30) Foreign Application Priority Data
Jul. 10, 2000 (FI) 20001639

(51) Int. Cl. H04M 1/00

(52) U.S. Cl. 455/575.1; 455/550.1

(57) ABSTRACT

The invention relates to a waterproof and form-fitting mobile telephone casing comprising a mainly rigid casing body (2) formed from a waterproof material and a substantially waterproof capping piece (3) and part of the shell of the casing body consists of transparent elastic material (4) so that the keys of a telephone placed inside the casing can be operated through the material (4). The casing body (2) comprises at least one waterproof and resilient bellows structure (6) for adapting the form of the casing body to the design and size of the mobile telephone to be fitted into the casing body.

The present invention relates to a waterproof and form-fitting casing for a mobile telephone as defined in the preamble of claim 1.

With the increasing use of mobile telephones, there has appeared a need to develop casings suited for the protection of mobile telephones. In prior art, various leather and plastic casings having a thin plastic film or elastic material covering the keys of the telephone are known. Thus, the telephone can be used while it is in the casing. Plastic casings made of hard plastic additionally effectively protect the telephone from hard impacts.

The problem is that prior-art casings have been designed without considering the differences between mobile telephone models manufactured by different manufacturers and that the same user may have several mobile telephones of different designs for different situations. Therefore, the use of existing casings is limited because a given casing model can only be used with a given telephone model.

The object of the invention is to eliminate the above-mentioned disadvantages. A specific object of the invention is to launch a new type of casing for a mobile telephone that is suited for use as a casing for several different mobile telephone types and models, at the same time protecting the mobile telephone both against mechanical stress and effectively protecting it from water, dust and humidity. A further object of the invention is to minimize the size of a casing suited for different mobile telephone models.

As for the features characteristic of the mobile telephone casing of the invention, reference is made to the claims.

The waterproof and form-fitting mobile telephone casing of the invention comprises a mainly rigid elongated casing body made of a waterproof material, e.g. plastic, and a substantially waterproof, at least splash-proof capping piece. Part of the casing body consists of transparent elastic material, e.g. relatively thin plastic, so that the keys and display of a mobile telephone inside the casing can be both seen and operated through the elastic material. According to the invention, the casing body of the mobile telephone casing comprises at least one waterproof and resilient bellows-type folding structure for adapting the form of the casing body to the design and size of different mobile telephone models. The form-fitting mobile telephone casing is expressly based on a change occurring in the structure, on the form/bellows being straightened out, not on stretchability of the material.

In this context, ‘bellows’ refers to a fold, pleat, plication or a similar structure which is capable of being stretched/deformed elastically when necessary and which resiles to its original position after being stretched.

In an embodiment of the invention, the resilient structure is placed in conjunction with a side wall and/or bottom of the casing body. The bellows is/are preferably placed in the bottom of the casing body and in the lower part of the side walls longitudinally with respect to the casing body.

In an embodiment of the invention, the resilient structure is an accordion-type structure comprising at least two bellows.

In an embodiment of the invention, the bellows is designed to stretch elastically in the depthwise direction of the mobile telephone casing so that the distance between the front wall and the back wall of the casing body increases, especially in the lower part of the casing body. In an embodiment, the bellows is designed to stretch elastically in the widthwise direction of the mobile telephone casing so that the distance between the side walls of the casing body increases, especially in the lower part of the casing body.

In this context, ‘front wall’ refers to the front part of the casing body, which has been formed from a partially transparent material and through which the keypad is operated. ‘Back wall’ means the back part of the casing body and is formed from entirely rigid material. ‘Side wall’ refers to the side of the casing body between the front wall and the back wall.

In an embodiment, the upper part or mouth of the casing body is formed from a substantially hard material, allowing the capping piece to be easily set in place.

In an embodiment of the invention, the upper part of capping piece of the mobile telephone casing is provided with at least two inlets, and the mobile telephone casing comprises at least one watertight plug fitted to the inlets in the capping piece, said plug being detachable and replaceable so as to allow telephones of different designs to be fitted into the mobile telephone casing. The inlets may preferably be of a circular shape and symmetrical with respect to each other, e.g. mirror images of each other, so that the plug can be placed in any one of the inlets.

In an embodiment of the invention, the capping piece belonging to the mobile telephone casing is formed from a substantially hard material and has two inlets in its upper part. In an embodiment, the mobile telephone casing comprises two plugs, which are set tightly into the inlets to close them. In an embodiment, the plugs are substantially identical. The plugs may naturally also be different. The plug may be an antenna plug designed to accommodate the antenna of the telephone when the telephone is inside the casing, or a flat stopper cap. A stopper cap can be used e.g. in situations where the casing houses a telephone having no antenna. In an embodiment, the plug can be replaced with a corresponding tight accessory plug matching the inlet and having a useful electronic additional function, such as FM radio, a flashlight, a watertight hands-free inlet, a safety alarm, a speaker element or some other additional function, such as a key case, capsule, bottle opener, multi-function tool or equivalent.

In an embodiment of the invention, the inlet in the capping piece and the foot of the plug are provided with threads or a snap or bayonet mechanism to allow easy fastening of the plug in the inlet. The plug may preferably be partly or completely formed form the same material as the capping piece. Alternatively, the plug may be made of any suitable waterproof material.

In an embodiment of the invention, the mobile telephone casing comprises a spring structure to press the telephone inside the casing toward the front wall and the transparent elastic material. The spring structure is placed inside the casing body, in conjunction with the back wall, and it is removable. In an embodiment, the spring structure is of a pocket-like design, allowing the pocket thus formed to hold e.g. a credit card, bank notes etc., protected from humidity, water or dust. In an embodiment, the spring structure is formed from plastic.

In an embodiment of the invention, the mobile telephone casing comprises a connecting means for connecting the casing body and the capping piece to each other and to allow the capping piece to be more easily opened and closed, said connecting means comprising an eccentric element and a slide element, said slide element permitting the capping piece to be slid open and back into the closed position. By means of the eccentric element, the capping piece can be locked watertightly onto the casing body. In an embodiment, the eccentric element comprises a lever rod connected to the casing body and an eccentric fastening mechanism. The eccentric fastening mechanism tightens the juncture between the casing body and the capping piece with a great force, thus producing a watertight juncture. In an embodiment, the slide element is placed inside the lever rod and comprises a staff and a slide fastener connected to the capping piece. Thus, the capping piece can be moved by means of the slide fastener along the staff straight upward/downward, preventing the capping piece from hitting the antenna of the telephone in the casing. In an embodiment, the capping piece can be turned with respect to the lever rod. The slide mechanism allows the capping piece to be easily opened and closed, even with one hand, and the capping piece remains attached to the casing body and will not be lost.

In an embodiment of the invention, the mobile telephone casing comprises at least one thinned portion or opening to improve the audibility of sound through the casing, and a waterproof diaphragm permitting sound transmission, preferably an audio diaphragm, e.g. a Gore-Tex diaphragm, placed in conjunction with the thinned portion or opening. The thinned portion or opening may be placed on the front side of the capping piece and/or casing body of the mobile telephone casing, in the hard part or in the elastic material. In an embodiment, the mobile telephone casing comprises two openings provided with waterproof diaphragms.

A waterproof or splash-proof mobile telephone casing structure is achieved by providing a sufficient tightness both between the casing body and the capping piece and between the capping piece and the plug/plugs and by using suitable seals or similar structures.

In an embodiment, the mobile telephone casing may comprise an actuating device as described in patent application FI 20000384 for operating a rotatable or otherwise adjustable key of the mobile telephone.

The mobile telephone casing and its parts are preferably manufactured from a plastic material suited for this application, e.g. from polyurethane, polyvinyl chloride, i.e. PCV, polyamide, styrene plastic such as ABS or equivalent, although other materials may also be used. The plastic materials used may contain reinforcing substances, such as glass, carbon or equivalent.

As compared with prior art, the mobile telephone casing of the invention has significant advantages:

a casing as small as possible and fit to be used with different mobile telephone models is achieved

waterproof casing affording resilience when necessary, e.g. lower part of casing body stretchable according to the dimensions of the telephone

possibility of modification of form, such as replaceability of plugs and elasticity/stretchability of the lower part of the casing body increase utilization of the casing

the plug is easy to replace

the replaceability of the plug part and the use of accessories allow additional functions to be incorporated in the mobile telephone casing

one and the same mobile telephone casing can be used to protect mobile telephones of different designs and sizes

an ecological alternative, e.g. no need to replace the mobile telephone casing when the user changes the telephone

the casing effectively protects the telephone from mechanical stress and moisture while still permitting unobstructed use of the telephone, and

the casing can be used to protect substantially any telephone on the market at present and in the future.

Moreover, the invention has the advantage that the mobile telephone casing can be manufactured by the economical die-casting technique, wherein the interior space of the casing is formed using a one-piece core. The interior space of the casing must have a downward tapering form to allow the core to be extracted from the casing without problems during manufacture. Before, a problem in the case of the widest telephone models was that this manufacturing technique could not be used in making the casing; if this technique was to be used to produce a prior-art casing for a telephone having a wide lower part, then the mouth of the casing had to be made unreasonably large with respect to the telephone. The present invention makes it possible to manufacture the casing by the above-mentioned economical manufacturing technique because the casing in its basic state has a slightly downward tapering form but, as the lower part of the casing body is stretchable to dimensions, it can still accommodate a telephone of uniform width or a telephone having a wider lower part.

The mobile telephone casing of the invention can be used to protect any mobile telephone in any circumstances.

In the following, the invention will be described in detail with reference to the attached drawings, wherein

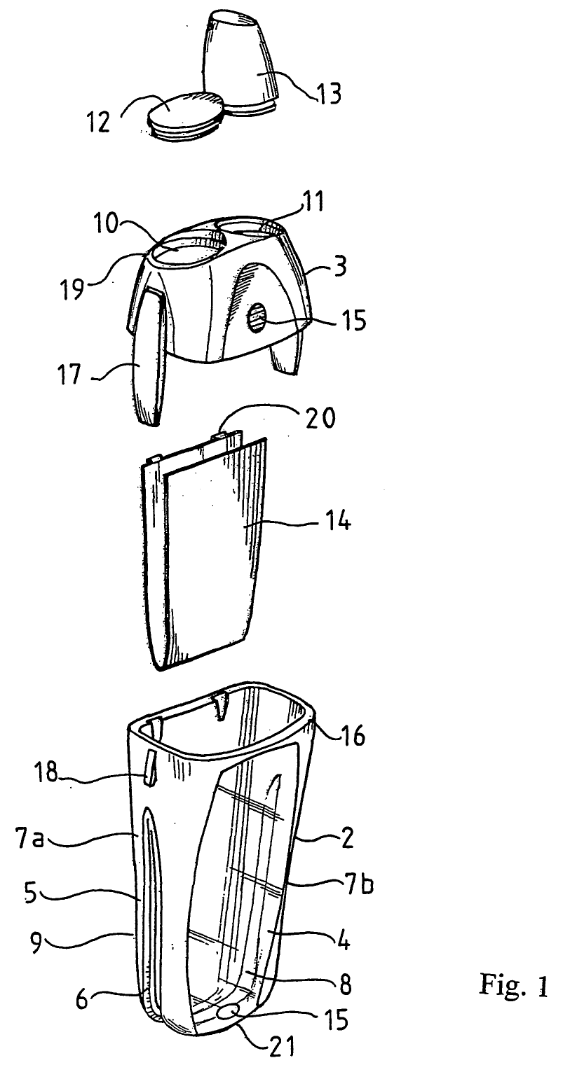

FIG. 1 presents a first embodiment of the mobile telephone casing of the invention in an oblique front/side view,

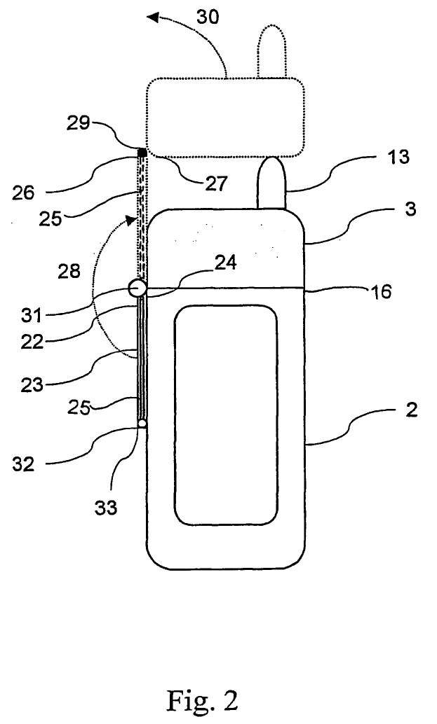

FIG. 2 presents a second embodiment of the mobile telephone casing of the invention in front view,

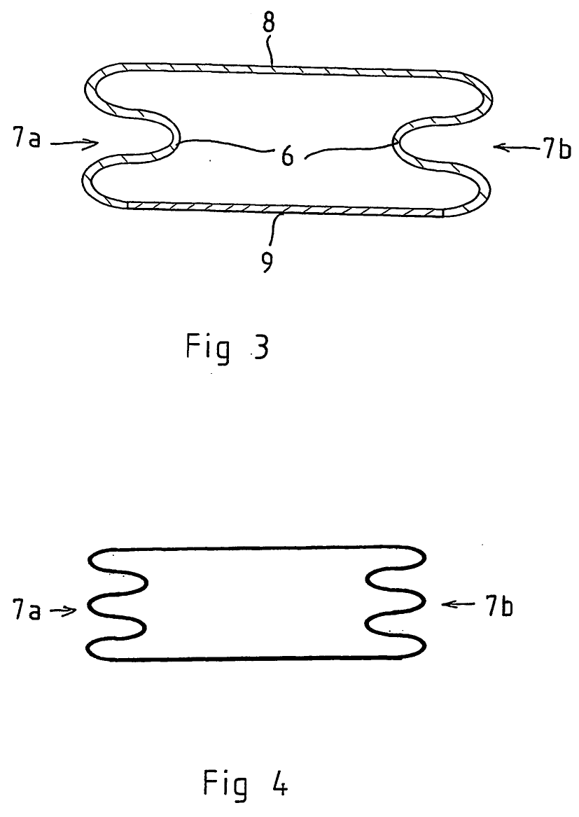

FIG. 3 presents a sectional view of the casing in FIG. 1, and

FIG. 4 presents a second alternative cross-section of the casing, corresponding to FIG. 3.

The mobile telephone casing presented in FIG. 1 comprises an elongated casing body 2 and a substantially waterproof (class IP67-IP68) or splash-proof (class IP154) capping piece 3. The juncture between the capping piece and the casing body is provided with sufficient seals to make the casing water/splashproof. The part of the shell of the casing body 2 on the front side 8 of the casing body has been formed from transparent, relatively thin and elastic and resilient material 4, e.g. plastic. Thus, a telephone, i.e. its keys, placed in the casing can be operated/pressed through the plastic. Likewise, the display of the mobile telephone can be read through the plastic. The upper part of the casing body 2, i.e. its mouth 16, and the back wall 9 and the capping piece 3 have been formed from a waterproof and hard kind of plastic known in itself.

The mobile telephone casing in FIG. 1 comprises a waterproof and resilient structure comprising one bellows 6, disposed on either side 7a and b and at the bottom 21 of the casing body. The bellows is placed in the lower part 5 of the casing body, in the side wall 7a,b and bottom 21 of the casing body, so that the bellows extends longitudinally in the side wall in the direction of the longitudinal axis of the casing body and further via the bottom to the other side wall in the same direction. The side walls 7a,b and the bottom 21 of the casing body as well as the bellows 6 are formed from rigid plastic that allows bending of the bellows while still protecting the telephone in the casing from impacts.

Alternatively, the resilient structure may consist of an accordion-type structure comprising at least two bellows to achieve an accordion-like property.

The capping piece 3 of the mobile telephone casing as presented in FIG. 1 comprises two symmetrical inlets 10 and 11 of a circular shape, placed in the upper part 19 of the capping piece. The mobile telephone casing further comprises two watertight plugs, a stopper cap 12 and an antenna plug 13, corresponding to the inlets 10 and 11 in the capping piece. The plugs are made of the same hard plastic material as the capping piece 3. The inner edge of each inlet 10 and 11 and the foot of each plug 12 and 13 is provided with a thread or a snap or bayonet mechanism, allowing the plugs to be fastened to the inlets quickly and easily. The plugs and the edges of the inlets are provided with seals, e.g. O-ring gaskets to make the casing waterproof.

In the embodiment shown in FIG. 1, the plugs 12 and 13 have symmetrical foot parts, so they can be mounted in any one of the inlets 10 and 11, depending on the placement of the antenna of the telephone in the casing. Alternatively, the antenna plug 13 may be replaced with another stopper cap 12 or an accessory plug if the telephone has no antenna at all. One or both of the plugs 12 and 13 can be replaced with an accessory plug in any situation. Alternatively, the inlets 10 and 11 can be plugged with a single continuous plug, which may contain some additional functions.

In the embodiment in FIG. 1, the capping piece 3 comprises connecting means 17 for connecting the capping piece to the casing body 2. To connect the capping piece 3 to the casing body 2, the connecting means 17 are fastened to counterparts 18 provided in the casing body 3 so that, using a separate sealing, a watertight casing body-capping piece juncture is achieved.

In an alternative embodiment presented in FIG. 2, the mobile telephone casing comprises a connecting means 22 designed to connect the casing body 2 and the capping piece 3 to each other and to allow easy opening and closing of the capping piece. The connecting means 22 comprises an eccentric element 23,31 and a slide element 25,26. The eccentric element comprises a lever rod 23 connected by its first end 24 to the upper part 16 of the casing body 2 with an eccentric clamp mechanism 31 known in itself. The connecting mechanism comprises a shaft about which the lever rod can be turned through about 180 degrees. In its initial position, the lever rod extends along the side wall 7 of the casing body 2 so that the shaft part 31 is at the level of the edge of the mouth 16 of the casing body. The slide element is mounted inside the lever rod 23 and it comprises a staff 25 and a slide fastener 26 which can be moved along the staff 25. The capping piece 3 of the mobile telephone casing is fastened by its first end 27 to the slide fastener 26, which may comprise a joint, hinge or equivalent, allowing the capping piece to be turned about the joint with respect to the lever rod 23.

In the embodiment in FIG. 2, to open the capping piece 3 of the mobile telephone casing, the lever rod is turned from its initial position through about 180 degrees in direction 28, with the result that the eccentric mechanism 31 releases the locking of the capping piece 3, thus allowing the capping piece to be easily slid straight upward along the staff 25 by means of the slide fastener 26, the capping piece being lifted at the same time. After the slide fastener 26 has reached the end 29 of the staff, i.e. its extreme position, the capping piece can be turned in direction 30 about the slide fastener. To close the capping piece 3, the capping piece is first slid back against the casing body 2 and the lever rod 23 is turned down to its initial position, whereupon the eccentric mechanism 31 locks the capping piece watertightly against the casing body. The eccentric element is so disposed that, when the capping piece is being closed, the lever rod turns past the so-called dead center, being thereby automatically pressed against the casing body. In addition, the connecting means 22 may comprise a locking element 32 for locking the end 33 of the lever rod 23 against the casing body 2. This ensures that the locking produced by the eccentric element will not be inadvertently released.

By using such a connecting means, the size of the mobile telephone casing can be minimized while at the same time producing a casing for mobile telephones of different designs.

The mobile telephone casing in FIG. 1 further comprises a pocket-like spring structure 14 formed from plastic and designed to press the telephone, especially a small telephone, inside the casing toward the front wall 8 and the transparent elastic material 4 of the casing body. The spring structure 14 is placed inside the casing body and it is fastened to the inner surface of the back wall 9 using fastening means 20 and a fastening method known in themselves. The spring structure 14 can be quickly and easily removed from the casing body 2 when necessary. The pocket-like design of the spring structure allows credit cards and bank notes to be kept inside it e.g. at the same time when there is a telephone in the casing.

In the embodiment in FIG. 1, the mobile telephone casing comprises two apertures 15 to improve the audibility of sound through the casing. One of the apertures 15 is located on the front side of the capping piece 3 and the other in the lower part of the front side 8 on in the bottom 21 of the casing body, so that they are substantially aligned with the microphone/speaker of the telephone. Fastened to the apertures 15 are waterproof audio diaphragms to ensure a waterproof structure. The audio diaphragms can be fastened using a sticker or by gluing or in any other known way. Alternatively, the mobile telephone casing may have only one aperture to improve the audibility of sound.

When a mobile telephone is being inserted into a mobile telephone casing according to the invention, the form of the casing adapts itself to the telephone. In the case of a small telephone, the appearance of the casing will not undergo any perceivable change because, in its basic state, the casing has been designed according to the dimensions of the smallest telephones on the market. Thus, even the smallest telephone will be held tightly in the mobile telephone casing, and its keys can be easily operated through the elastic material. In the case of a large telephone of e.g. uniform width, the lower part of the casing will be deformed elastically according to the size of the telephone. The bellows will be stretched from its initial position, i.e. straightened out enough for the telephone to be accommodated inside the casing body, while the depthwise distance between the front wall and the back wall of the casing body as well as the widthwise distance between the side walls are increased by an amount corresponding to the size of the telephone. When the casing is to be used to protect a large telephone, the spring structure can be removed from inside the casing. On the other hand, the spring structure will yield and be elastically folded to a flatter form toward the back wall of the casing body. The plug solutions for the mobile telephone casing are partly selected according to the situation of application and partly according to the type of the antenna solution used in the telephone to be kept in the casing. When the telephone is taken out of the casing, the structure of the casing body resumes its initial position. In an alternative embodiment, after the telephone has been taken out, the casing may retain the size and form it had while the telephone was in it, e.g. by the aid of an external tensioning mechanism. In this case, when a new telephone is to be placed in the casing, the tensioning mechanism or equivalent has to be adjusted for the new telephone.

The main point about placing a telephone in the mobile telephone casing is that the telephone will be set tightly inside the casing, thus allowing easy operation of its keys through the elastic material.

The mobile telephone casing presented in FIG. 1 may additionally comprise am actuating means as described in patent application FI 20000384, by means of which a rotatable or otherwise movable key of e.g. roller-like design of the mobile telephone can be operated through the elastic material 4. In addition, the mobile telephone casing may also comprise other technical details and solutions described in patent applications FI 20000384 and PCT/FI99/00705 or other corresponding details known in themselves, e.g. a belt clip or the like.

The mobile telephone casing may be implemented in any shape and it may be used to protect any kind of telephone.

FIG. 3 presents a sectional view of the mobile telephone casing shown in FIG. 1. The back wall 9 is made of hard plastic. Both sides 7a and 7b of the casing are bellows structures 6 made of flexible plastic, which can be elastically deformed and stretched or straightened when a telephone is being inserted into the casing. The front side 8 of the casing is also part of the same flexible structure, permitting the keys of the telephone to be operated through the elastic structure.

FIG. 4 presents a cross-sectional view of another embodiment, in which the sides 7a and 7b of the casing consist of accordion-like structures comprising several folds. In this manner, the flexibility of the sides can be further increased.

In the foregoing, the invention has been described by way of example with reference to the attached drawings while different embodiments of the invention are possible within the inventive idea defined in the claims.

1. Waterproof and form-fitting mobile telephone casing, comprising a mainly rigid casing body (2) formed from waterproof material and a substantially waterproof capping piece (3) and part of the shell of the casing body consists of transparent elastic material (4) so that the keys of a telephone placed inside the casing can be operated through the material (4), characterized in that the casing body (2) comprises at least one waterproof and resilient bellows structure (6) for adapting the form of the casing body to the design and size of the mobile telephone to be fitted into the casing body.

2. Casing as defined in claim 1, characterized in that the resilient structure (6) is placed in a side wall (7a,b) and/or the bottom (21) of the casing body.

3. Casing as defined in claim 1 or 2, characterized in that the resilient structure is an accordion-type structure comprising at least two bellows (6).

4. Casing as defined in any one of claims 1-3, characterized in that the bellows (6) is designed to stretch elastically in the depthwise direction of the mobile telephone casing so that the distance between the front wall (8) and the back wall (9) of the casing body increases.

5. Casing as defined in any one of claims 1-4, characterized in that the bellows (6) is designed to stretch elastically in the widthwise direction of the mobile telephone casing so that the distance between the side walls (7a,b) of the casing body increases.

6. Casing as defined in any one of claims 1-5, characterized in that the capping piece (3) comprises at least two inlets (10,11) placed in the upper part (19) of the capping piece, and the mobile telephone casing comprises at least one watertight plug (12,13) fitted to the inlets in the capping piece, said plug being removable and replaceable to allow telephones of different designs to be fitted into the mobile telephone casing.

7. Casing as defined in any one of claims 1-6, characterized in that the capping piece (3) has been formed from a substantially hard material and has two inlets (10,11) in its upper part (19).

8. Casing as defined in any one of claims 1-7, characterized in that the mobile telephone casing comprises two plugs (12,13).

9. Casing as defined in any one of claims 1-8, characterized in that the plugs (12,13) are substantially identical.

10. Casing as defined in any one of claims 1-9, characterized in that the plug is an antenna plug (13).

11. Casing as defined in any one of claims 1-10, characterized in that the plug is a stopper cap (12).

12. Casing as defined in any one of claims 1-11 characterized in that the plug comprises an accessory for implementing an electronic additional function.

13. Casing as defined in any one of claims 1-12, characterized in that the inlet (10,11) in the capping piece and the foot of the plug (12,13) are provided with threads or a snap or bayonet mechanism for fastening the plug to the inlet.

14. Casing as defined in any one of claims 1-13, characterized in that the mobile telephone casing comprises a spring structure (14) for pressing the telephone inside the casing toward the front wall (8) of the casing body and the transparent elastic material (4), which spring structure is placed inside the casing body (2) and detachably connected to the inner surface of the back wall (9).

15. Casing as defined in any one of claims 1-14, characterized in that the spring structure (14) is of a pocket-like design.

16. Casing as defined in any one of claims 1-15, characterized in that the mobile telephone casing comprises a connecting means (22) serving to connect the casing body (2) and the capping piece (3) to each other and to facilitate the opening and closing of the capping piece, said connecting means comprising an eccentric element (23,31) and a slide element (25,26) so that the capping piece (3) can be slid open and back into the closed position by means of the slide element (25,26) and locked by means of the eccentric element (23,31).

17. Casing as defined in any one of claims 1-16, characterized in that the mobile telephone casing comprises at least one thinned portion or aperture (15) for improving the audibility of sound through the casing, and a waterproof diaphragm permitting sound transmission, placed on the thinned portion or aperture.
